(19) United States
(12) Patent Application Publication
(10) Pub. No.: US 2024/0204202 A1
(43) Pub. Date: Jun. 20, 2024

(54) LITHIUM-ION SECONDARY BATTERY AND METHOD FOR PRODUCING SAME

(71) Applicant: Prime Planet Energy & Solutions, Inc., Tokyo (JP)

(72) Inventors: Yoshitomo TAKEBAYASHI, Nisshin-shi (JP); Kazuma MIMA, Toyota-shi (JP)

(21) Appl. No.: 18/494,771

(22) Filed: Oct. 26, 2023

(30) Foreign Application Priority Data
Dec. 19, 2022 (JP) 2022-202327

(51) Int. Cl. H01M 4/66; H01M 4/04; H01M 4/62; H01M 10/0525; H01M 10/0568; H01M 10/0587; H01M 50/609

(52) U.S. Cl. CPC H01M 4/667; H01M 4/0447; H01M 4/628; H01M 4/661; H01M 10/0525; H01M 10/0568; H01M 10/0587; H01M 50/609; H01M 2004/028

(57) ABSTRACT

A lithium-ion secondary battery includes: a wound electrode body including a strip-shaped positive electrode plate, a strip-shaped negative electrode plate, and a strip-shaped separator, which are wound so that the separator is interposed between the positive and negative electrode plates; a nonaqueous electrolytic solution containing LiPF₆; and a battery case in which the wound electrode body and the nonaqueous electrolytic solution are stored. The positive electrode plate includes a positive current collecting foil formed of an aluminum foil, and a positive active material layer laminated on a surface of this foil. An amount of AlF₃ per unit area is greater on surfaces of current collecting foil end portions of a positive electrode laminated part than on a surface of a current collecting foil central portion of the positive electrode laminated part.

### CROSS-REFERENCE TO RELATED APPLICATIONS

This application is based upon and claims the benefit of priority to Japanese Patent Application No. 2022-202327 filed on Dec. 19, 2022, the entire contents of which are incorporated herein by reference.

### BACKGROUND

### Technical Field

The present disclosure relates to a lithium-ion secondary battery, and a method for producing the same.

### Related Art

Japanese unexamined patent application publication No. 2018-060689 (JP2018-060689 A) discloses a method for producing a lithium-ion secondary battery that includes a positive electrode plate having a positive active material layer on a surface of a positive current collecting foil formed of an aluminum foil, a negative electrode plate, and a nonaqueous electrolytic solution containing LiPF₆.

### SUMMARY

### Technical Problems

In a lithium-ion secondary battery that includes a positive electrode plate having a positive active material layer on a surface of a positive current collecting foil formed of an aluminum foil, a negative electrode plate, and a nonaqueous electrolytic solution containing LiPF₆, when high-load energization such as quick charging is performed, the positive current collecting foil may locally have a high potential. More specifically, in a lithium-ion secondary battery that includes a wound electrode body in which a strip-shaped positive electrode plate, a strip-shaped negative electrode plate, and strip-shaped separators are wound so that the separators are alternately interposed between the positive electrode plate and the negative electrode plate, when high-load energization such as quick charging is performed, portions of the positive current collecting foil included in a positive electrode laminated part, at both ends in the axial direction of the wound electrode body, which are referred to as current collecting foil end portions or simply referred to as foil end portions of the positive electrode laminated part, may have a high potential. The positive electrode laminated part is a portion of the positive electrode plate, in which the positive active material layer is laminated on the surface of the positive current collecting foil.

If the foil end portion of the positive electrode laminated part which has a high potential corrodes, Al (aluminum) may be eluted from a surface of the corroded portion, and the eluted aluminum is accumulated on the surface of the negative electrode, so that internal short-circuiting may be caused. More specifically, in a lithium-ion secondary battery at an initial, or early, stage of use, a highly corrosion-resistant AlF₃ coating is not sufficiently formed on the surface of the positive current collecting foil, and the above-described corrosion may thus cause elution of Al.

For addressing this, in the lithium-ion secondary battery disclosed in JP2018-060689A, LiBF₄ and LiFOB are added in the nonaqueous electrolytic solution as an additive for promoting formation of an AlF₃ coating on the surface of the positive current collecting foil. However, cost for these additives is high, and formation of an AlF₃ coating is insufficient at the initial use stage, and elution of Al may thus be caused due to corrosion when high-load energization such as quick charging is performed.

The present disclosure has been made in view of such circumstances, and an object of the present disclosure is to provide a lithium-ion secondary battery that can reduce elution of Al from a surface of positive current collecting foil in the case of high-load energization being performed at an initial use stage, and a method for producing the lithium-ion secondary battery.

### Means of Solving the Problems

(1) To achieve the above-mentioned purpose, one aspect of the present disclosure provides a lithium-ion secondary battery comprising: a wound electrode body including a strip-shaped positive electrode plate, a strip-shaped negative electrode plate, and a strip-shaped separator, which are wound so that the separator is interposed between the positive electrode plate and the negative electrode plate; a nonaqueous electrolytic solution containing LiPF₆; and a battery case in which the wound electrode body and the nonaqueous electrolytic solution are stored, wherein the positive electrode plate includes a positive current collecting foil formed of an aluminum foil, and a positive active material layer laminated on a surface of the positive current collecting foil, and the positive electrode plate is configured such that: a positive electrode laminated part is defined by a portion in which the positive active material layer is laminated on the surface of the positive current collecting foil, and the positive electrode laminated part includes: current collecting foil end portions, which are end portions of the positive current collecting foil included in the positive electrode laminated part, the end portions being located at both ends of the positive electrode laminated part in an axial direction of the wound electrode body; and a current collecting foil central portion, which is a central portion of the positive current collecting foil included in the positive electrode laminated part, the central portion being located at a center of the positive electrode laminated part in the axial direction of the wound electrode body, and an amount of AlF₃ per unit area is greater on each of surfaces of the current collecting foil end portions of the positive electrode laminated part than on a surface of the current collecting foil central portion of the positive electrode laminated part.

In the above-described lithium-ion secondary battery, an amount of AlF₃ per unit area is greater on each of the surfaces of the foil end portions of the positive electrode laminated part than on the surface of the current collecting foil central portion (which is also simply referred to as the foil central portion) of the positive electrode laminated part. Therefore, a thickness of an AlF₃ coating is greater on each of the surfaces of the foil end portions of the positive electrode laminated part than on the surface of the foil central portion of the positive electrode laminated part. In the lithium-ion secondary battery configured as above, corrosion resistance is higher on the surfaces of the foil end portions of the positive electrode laminated part than on the surface of the foil central portion of the positive electrode laminated part.

That is, in the above-described lithium-ion secondary battery, in the positive current collecting foil included in the positive electrode laminated part, corrosion resistance is selectively enhanced on the surfaces of the foil end portions of the positive electrode laminated part. Al is likely to be eluted due to corrosion on the surfaces of the foil end portions of the positive electrode laminated part, in the positive current collecting foil included in the positive electrode laminated part, when high-load energization is performed at the initial use stage of the battery. Therefore, the above-described lithium-ion secondary battery can reduce elution of Al from the surface of the positive current collecting foil in the case of high-load energization being performed at the initial use stage.

The greater an amount of AlF₃ per unit area is on the surface of the positive current collecting foil included in the positive electrode laminated part, the lower a discharge capacity of the lithium-ion secondary battery tends to be. Therefore, for example, if an amount of AlF₃ per unit area is increased over the whole surface of the positive current collecting foil included in the positive electrode laminated part in order to enhance corrosion resistance, a discharge capacity of the lithium-ion secondary battery may be significantly reduced.

Meanwhile, in the above-described lithium-ion secondary battery, an amount of AlF₃ per unit area is selectively increased at a portion that is likely to corrode, that is, at the surfaces of the foil end portions of the positive electrode laminated part when high-load energization is performed at the initial use stage of the battery. Thus, reduction of a discharge capacity of the lithium-ion secondary battery can be made small as compared with a case where an amount of AlF₃ per unit area is increased over the whole surface of the positive current collecting foil included in the positive electrode laminated part.

(2) Another aspect of the present disclosure provides a method for producing the lithium-ion secondary battery described in (1), the method comprising: forming the positive electrode plate including the positive active material layer on the surface of the positive current collecting foil; forming the wound electrode body by winding the positive electrode plate, the negative electrode plate, and the separator so that the separator is interposed between the positive electrode plate and the negative electrode plate; storing the wound electrode body in the battery case; injecting the nonaqueous electrolytic solution into the battery case in which the wound electrode body is stored, and forming a solution-injected battery into which the solution has been injected; and initially charging the solution-injected battery, wherein, in forming the positive electrode plate, hydroxide particles are supplied so as to be contained only in positive active material layer end portions existing on the surfaces of the current collecting foil end portions of the positive electrode laminated part in the positive active material layer.

In the above-described production method, in the positive electrode plate forming process, the hydroxide particles are supplied so as to be contained only in the positive active material layer end portions of the positive active material layer, existing on the surfaces of the foil end portions of the positive electrode laminated part. Thus, the lithium-ion secondary battery can be produced, in which an amount of AlF₃ per unit area is greater on each of the surfaces of the foil end portions of the positive electrode laminated part than on the surface of the foil central portion of the positive electrode laminated part. Since the hydroxide particles are contained in the positive active material layer, an AlF₃ coating having high corrosion resistance is easily formed on the surface of the positive current collecting foil.

Specifically, in a period from after the nonaqueous electrolytic solution is injected into the battery case in which the positive electrode plate and the like are stored until the battery is completed and enters a delivery waiting state, an AlF₃ coating generation reaction is promoted on the surface of the positive current collecting foil in a portion of the positive electrode plate in which the hydroxide particles are contained. Particularly, in the initial charging step, the AlF₃ coating generation reaction is promoted. Therefore, the above-described production method can produce the lithium-ion secondary battery in which an amount of AlF₃ per unit area is greater on each of the surfaces of the foil end portions of the positive electrode laminated part than on the surface of the foil central portion of the positive electrode laminated part.

As described above, Al is likely to be eluted due to corrosion on the surfaces of the foil end portions of the positive electrode laminated part, in the positive current collecting foil included in the positive electrode laminated part, when high-load energization is performed at the initial use stage of the battery. Therefore, the above-described production method can produce the lithium-ion secondary battery which allows reduction of elution of Al from the surface of the positive current collecting foil in the case of high-load energization being performed at the initial use stage.

In a case where LiOH particles are used as the hydroxide particles to be contained in the positive active material layer end portions, an AlF₃ coating having high corrosion resistance is formed on the surfaces of the foil end portions (aluminum foil) of the positive electrode laminated part through a series of the following reactions (a) to (c). The surface of the positive current collecting foil used in the positive electrode plate forming step is covered with an Al₂O₃ coating that is an oxide film.

(a) LiOH in the positive active material layer end portions is decomposed to generate H₂O.

2LiOH→Li₂O+H₂O (Formula 1)

(b) The generated H₂O reacts with LiPF₆ in the nonaqueous electrolytic solution to generate HF.

LiPF₆+H₂O→LiF+POF₃+2HF (Formula 2)

(c) The generated HF reacts with Al₂O₃ coatings on the surfaces of the foil end portions of the positive electrode laminated part to generate AlF₃ coatings on the surfaces of the foil end portions of the positive electrode laminated part.

Al₂O₃+6HF→2AlF₃+3H₂O (Formula 3)

Also in a case where hydroxide particles other than LiOH particles are used as hydroxide particles to be contained in the positive active material layer end portions, the hydroxide particles are decomposed in the positive active material layer end portions to generate H₂O. Thus, the reactions represented by the above-described Formula 2 and Formula 3 are caused to generate AlF₃ coatings on the surfaces of the foil end portions of the positive electrode laminated part.

A proportion of the hydroxide particles to be contained in the positive active material layer end portions is preferably 0.5 wt % or higher with respect to components other than the hydroxide particles in the positive active material layer end portions. Thus, an AlF₃ coating is more easily formed on the surfaces of the foil end portions of the positive electrode laminated part, and elution of Al from the surfaces of the foil end portions of the positive electrode laminated part can be prevented.

(3) In the method for producing the lithium-ion secondary battery, described in (2), furthermore, the hydroxide particles may be LiOH particles.

In a case where LiOH particles are used as the hydroxide particles to be contained in the positive active material layer end portions, an AlF₃ coating generation reaction is promoted on the surfaces of the foil end portions of the positive electrode laminated part in the battery producing process as described above. Therefore, also in a case where high-load energization is performed at the initial use stage of the battery, elution of Al from the surfaces of the foil end portions of the positive electrode laminated part can be reduced. Furthermore, it is advantageous that decomposition of LiOH contained in the positive active material layer end portions causes generation of Li useful for a lithium-ion secondary battery.

(4) Still another aspect of the present disclosure provides a method for producing the lithium-ion secondary battery described in (1), the method comprising: forming the positive electrode plate including the positive active material layer on the surface of the positive current collecting foil; forming the wound electrode body by winding the positive electrode plate, the negative electrode plate, and the separator so that the separator is interposed between the positive electrode plate and the negative electrode plate; storing the wound electrode body in the battery case; injecting the nonaqueous electrolytic solution into the battery case in which the wound electrode body is stored, and forming a solution-injected battery into which the solution has been injected; and initially charging the solution-injected battery, wherein injecting the nonaqueous electrolytic solution is performed by injecting the nonaqueous electrolytic solution into the battery case that stores the wound electrode body configured such that: each of an amount of water in positive active material layer end portions of the positive active material layer, existing on each of the surfaces of the current collecting foil end portions of the positive electrode laminated part, is equal to or higher than 100 ppm; and an amount of water in a positive active material layer central portion of the positive active material layer, existing on the surface of the current collecting foil central portion of the positive electrode laminated part, is less than each of the amount of water in the positive active material layer end portions.

In the above-described production method, in the solution injecting step, the nonaqueous electrolytic solution is injected in the battery case that stores the wound electrode body satisfying the following two conditions of (d) and (e). One condition (d) is that an amount of water (water content) at each of the positive active material layer end portions existing on the surfaces of the foil end portions of the positive electrode laminated part in the positive active material layer is equal to or higher than 100 ppm. The other condition (e) is that an amount of water (water content) at the positive active material layer central portion existing on the surface of the foil central portion of the positive electrode laminated part in the positive active material layer is less than the amount of water in each of the positive active material layer end portions.

Thus, the lithium-ion secondary battery can be produced, in which an amount of AlF₃ per unit area is greater on each of the surfaces of the foil end portions of the positive electrode laminated part than on the surface of the foil central portion of the positive electrode laminated part. This is because the greater an amount of water in the positive active material layer is when the solution injecting step is performed, the more easily an AlF₃ coating having high corrosion resistance is formed on the surface of the positive current collecting foil in a period from after injection of the electrolytic solution into the battery case to delivery of the battery. Particularly, in a case where the solution injecting step is performed in a state where an amount of water in the positive active material layer is 100 ppm or higher, an AlF₃ coating having high corrosion resistance is easily formed on the surface of the positive current collecting foil in the period from after injection of the electrolytic solution into the battery case to delivery of the battery. Specifically, in the initial charging step, an AlF₃ coating generation reaction is promoted, and corrosion resistance becomes high on the surface of the positive current collecting foil. In a conventional production method, an amount of water contained in the positive active material layer is reduced as much as possible, and the amount of water in the positive active material layer is significantly lower than 100 ppm.

Therefore, the above-described production method enables production of the lithium-ion secondary battery in which an amount of AlF₃ per unit area is greater on each of the surfaces of the foil end portions of the positive electrode laminated part than on the surface of the foil central portion of the positive electrode laminated part. As described above, Al is likely to be eluted due to corrosion on the surfaces of the foil end portions of the positive electrode laminated part, in the positive current collecting foil included in the positive electrode laminated part, when high-load energization is performed at the initial use stage of the battery. Therefore, the above-described production method can achieve the lithium-ion secondary battery which allows reduction of elution of Al from the surface of the positive current collecting foil in the case of high-load energization being performed at an initial use stage.

In the above-described production method, an AlF₃ coating having high corrosion resistance is formed on the surface of the positive current collecting foil (aluminum foil) through a series of the following reactions (f) and (g). The surface of the positive current collecting foil used in the positive electrode plate forming step is covered with an Al₂O₃ coating that is an oxide film. Therefore, the surface of the positive current collecting foil in the wound electrode body used in the solution injecting step is also covered with the Al₂O₃ coating.

(f) After the electrolytic solution is injected into the battery case in the solution injecting step, H₂O contained in the positive electrode plate in the battery case reacts with LiPF₆ in the electrolytic solution to generate HF.

LiPF₆+H₂O→LiF+POF₃+2HF (Formula 4)

(g) The generated HF reacts with the Al₂O₃ coating on the surface of the positive current collecting foil to generate an AlF₃ coating on the surface of the positive current collecting foil.

Al₂O₃+6HF→2AlF₃+3H₂O (Formula 5)

(5) The method for producing the lithium-ion secondary battery, described in (4) may further include, between storing the wound electrode body and injecting the nonaqueous electrolytic solution, adjusting each of the amount of water in the positive active material layer end portions such that each of the amount of water in the positive active material layer end portions is 100 ppm or higher but 290 ppm or less, and adjusting the amount of water in the positive active material layer central portion such that the amount of water in the positive active material layer central portion is less than each of the amount of water in the positive active material layer end portions.

The greater an amount of water in the positive active material layer is when the solution injecting step is performed, the more easily the AlF₃ coating is formed on the surface of the positive current collecting foil, and corrosion resistance of the surface of the positive current collecting foil can be enhanced. However, if an amount of water in the positive active material layer is excessively great, a discharge capacity of the lithium-ion secondary battery is reduced. Specifically, if an amount of water in the positive active material layer is equal to or higher than 290 ppm, a discharge capacity of the lithium-ion secondary battery is significantly reduced. Therefore, an amount of water in the positive active material layer is preferably 100 ppm or higher but 290 ppm or less, i.e., in a range from 100 ppm to 290 ppm inclusive, when the solution injecting step is performed.

Meanwhile, in the above-described production method, the following water amount adjustment step is performed between the storage step and the solution injecting step. Specifically, in the water amount adjustment step, an amount of water in the positive active material layer end portion is adjusted to be 100 ppm or higher but 290 ppm or less, and an amount of water in the positive active material layer central portion is adjusted to be less than the amount of water in the positive active material layer end portion. Thus, in the solution injecting step, the nonaqueous electrolytic solution can be injected into the battery case that stores the wound electrode body satisfying the following two conditions of (h) and (i). One condition (h) is that an amount of water in the positive active material layer end portion is 100 ppm or higher but 290 ppm or less. The other condition (i) is that an amount of water in the positive active material layer central portion is less than the amount of water in the positive active material layer end portion. By producing the lithium-ion secondary battery in such a manner, it is possible to reduce elution of Al from the surface of the positive current collecting foil in the case of high-load energization being performed at the initial use stage of the battery, and—suppress reduction of a discharge capacity of the battery.

### BRIEF DESCRIPTION OF THE DRAWINGS

FIG. 1 is a plan view of a lithium-ion secondary battery in each of an embodiment and a modified embodiment;

FIG. 2 is a front view of the lithium-ion secondary battery;

FIG. 3 is a plan view of a positive electrode plate of the lithium-ion secondary battery;

FIG. 4 is a cross-sectional view of the positive electrode plate in the embodiment as taken along a line B-B in FIG. 3;

FIG. 5 is a plan view of a negative electrode plate;

FIG. 6 is a cross-sectional view of the negative electrode plate as taken along a line C-C in FIG. 5;

FIG. 7 is a perspective view of a wound electrode body;

FIG. 8 is a flow chart showing a flow of a method for producing the lithium-ion secondary battery in the embodiment;

FIG. 9 is a diagram illustrating the method for producing the lithium-ion secondary battery;

FIG. 10 is a cross-sectional view of a positive electrode plate in the modified embodiment as taken along the line B-B in FIG. 3; and

FIG. 11 is a flow chart showing a flow of a method for producing a lithium-ion secondary battery in the modified embodiment.

### DETAILED DESCRIPTION OF THE EXEMPLARY EMBODIMENTS

### Embodiment

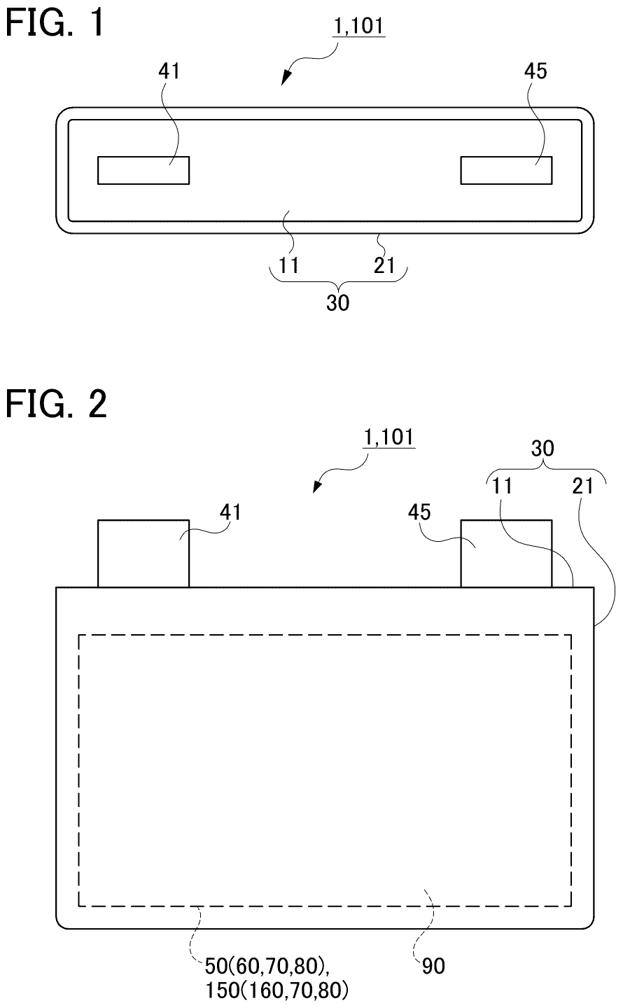

Next, an embodiment of the present disclosure will be described. A lithium-ion secondary battery 1 (hereinafter, also simply referred to as a battery 1) of the present embodiment includes a battery case 30, a wound electrode body 50 stored inside the battery case 30, a positive terminal member 41, and a negative terminal member 45 (see FIGS. 1 and 2). The battery case 30 is a hard case made of metal, and has a rectangular parallelepiped box-like shape. The battery case 30 includes a case body 21 that is made of metal and has a rectangular bottomed tube shape, and a lid 11 that is made of a metal and has a rectangular flat plate-like shape for closing an opening of the case body 21 (see FIGS. 1 and 2).

The lid 11 has two rectangular tubular through holes (a first through hole and a second through hole, which are not shown) formed therein. The positive terminal member 41 is inserted through the first through hole, and the negative terminal member 45 is inserted through the second through hole (see FIGS. 1 and 2). A tubular insulating member (not shown) is interposed between the inner peripheral surface of the first through hole of the lid 11 and the outer peripheral surface of the positive terminal member 41, and a tubular insulating member (not shown) is interposed between the inner peripheral surface of the second through hole of the lid 11 and the outer peripheral surface of the negative terminal member 45.

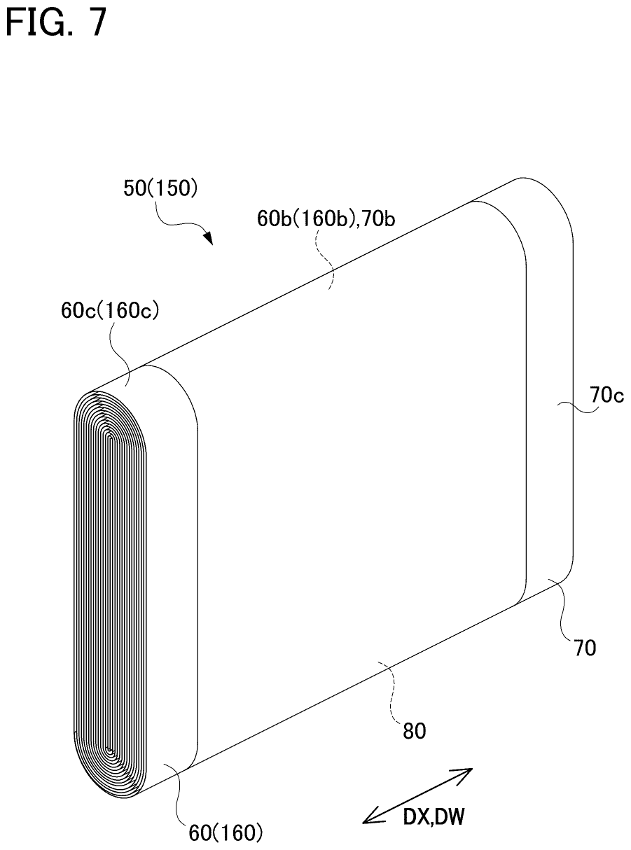

The wound electrode body 50 includes a strip-shaped positive electrode plate 60, a strip-shaped negative electrode plate 70, and strip-shaped separators 80, and the positive electrode plate 60, the negative electrode plate 70, and the separators 80 are wound so that the separators 80 are alternately interposed between the positive electrode plate 60 and the negative electrode plate 70 in the wound electrode body 50 (see FIG. 7). The wound electrode body 50 contains a nonaqueous electrolytic solution 90 therein (see FIG. 2). The nonaqueous electrolytic solution 90 is stored also on a bottom surface side in the battery case 30. In the wound electrode body 50, the positive electrode plate 60 is connected to the positive terminal member 41 inside the battery case 30, and the negative electrode plate 70 is connected to the negative terminal member 45 inside the battery case 30.

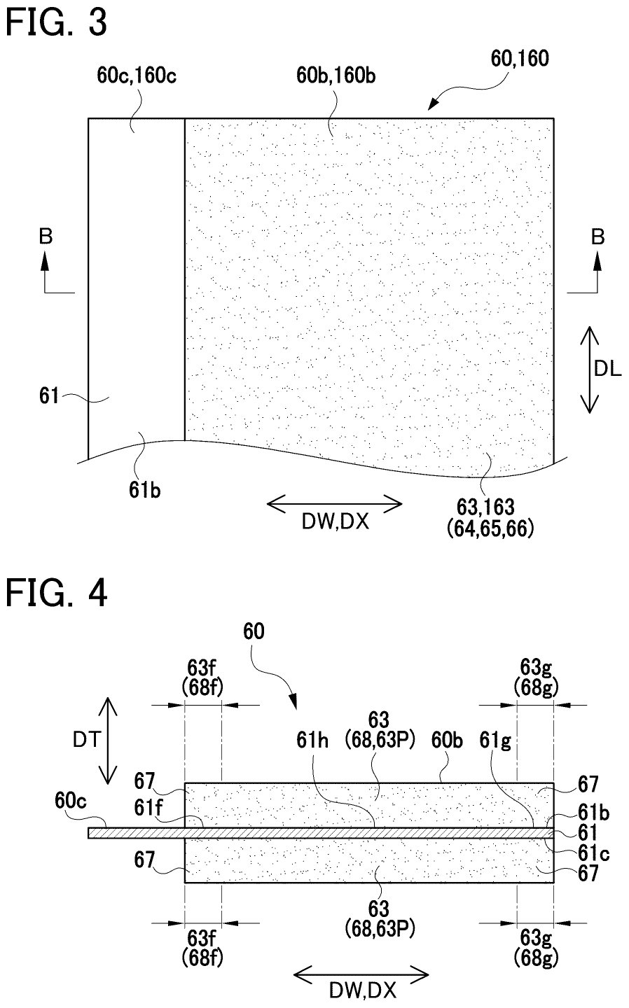

The positive electrode plate 60 is strip-shaped and extends in a longitudinal direction DL, and includes a positive current collecting foil 61 formed of an aluminum foil, and a positive active material layer 63 laminated on each surface (that is, a first surface 61b and a second surface 61c) of the positive current collecting foil 61 (see FIGS. 3 and 4). Each positive active material layer 63 contains positive active material particles 64, a binder 65, and a conductive material 66. In the present embodiment, the positive active material particles 64 are lithium transition metal composite oxide particles, specifically, Li(Ni_{1/3}Mn_{1/3}Co_{1/3})O₂ particles, the binder 65 is PVDF, and the conductive material 66 is acetylene black.

The positive electrode plate 60 includes a positive electrode laminated part 60b and a positive-electrode non-laminated part 60c (see FIGS. 3 and4). The positive electrode laminated part 60b and the positive-electrode non-laminated part 60c are adjacent to each other in a width direction DW of the positive electrode plate 60. The width direction DW is a direction perpendicular to the longitudinal direction DL. The positive electrode laminated part 60b is a portion of the positive electrode plate 60, in which the positive active material layers 63 are laminated one on each of the surfaces (i.e., the first surface 61b and the second surface 61c) of the positive current collecting foil 61. Meanwhile, the positive-electrode non-laminated part 60c is a portion of the positive electrode plate 60, in which the positive active material layer 63 is not laminated on any of the surfaces (i.e., the first surface 61b and the second surface 61c) of the positive current collecting foil 61, and is a portion only formed of the positive current collecting foil 61.

In the positive current collecting foil 61 included in the positive electrode laminated part 60b, portions located at both ends in the axial direction DX of the wound electrode body 50 are defined as current collecting foil end portions 61f and 61g (which are also simply referred to as foil end portions) of the positive electrode laminated part 60b (see FIG. 4). In the positive current collecting foil 61 included in the positive electrode laminated part 60b, a portion located at the central portion in the axial direction DX of the wound electrode body 50 is defined as a current collecting foil central portion 61h (which is simply referred to as a foil central portion 61h) of the positive electrode laminated part 60b. The width direction DW of the positive electrode plate 60 coincides with the axial direction DX of the wound electrode body 50 (see FIG. 7). Therefore, the foil end portions 61f and 61g of the positive electrode laminated part60b are located at both ends of the positive electrode laminated part 60b in the width direction DW. Meanwhile, the foil central portion 61h of the positive electrode laminated part 60b is located at the central portion of the positive electrode laminated part 60b in the width direction DW.

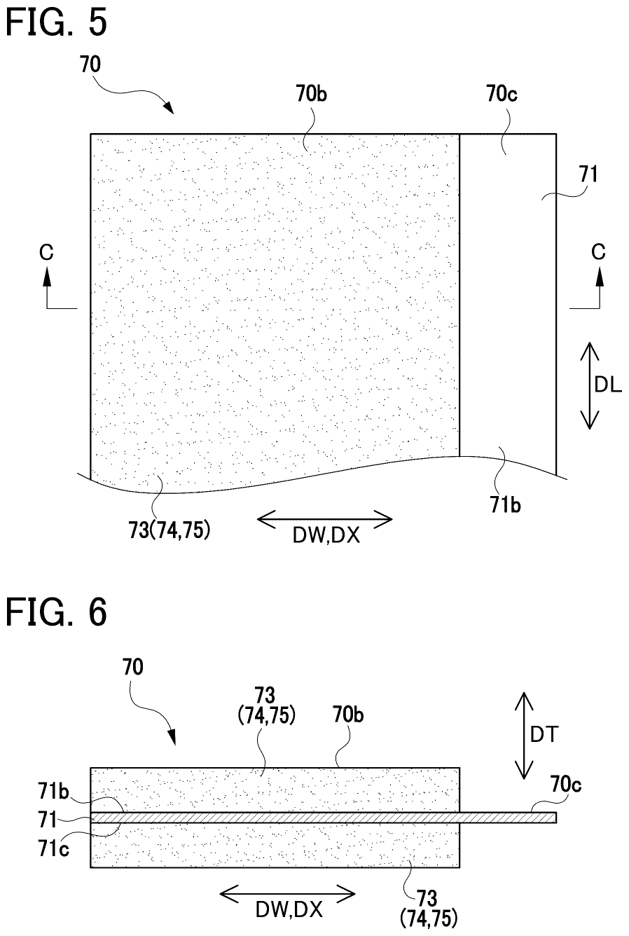

The negative electrode plate 70 is strip-shaped and extends in the longitudinal direction DL, and includes a negative current collecting foil 71 formed of a copper foil, and a negative active material layer 73 laminated on each surface (that is, a first surface 71b and a second surface 71c) of the negative current collecting foil 71 (see FIGS. 5 and 6). Each negative active material layer 73 contains negative active material particles 74 and a binder 75. In the present embodiment, the negative active material particles 74 are graphite particles, and the binder 75 is CMC (carboxymethylcellulose) and SBR (styrene-butadiene-rubber).

The negative electrode plate 70 includes a negative electrode laminated part 70b and a negative-electrode non-laminated part 70c (see FIGS. 5 and 6). The negative electrode laminated part 70b and the negative-electrode non-laminated part 70c are adjacent to each other in a width direction DW of the negative electrode plate 70. The width direction DW is a direction perpendicular to the longitudinal direction DL. The negative electrode laminated part 70b is a portion of the negative electrode plate 70, in which the negative active material layers 73 are laminated one on each of the surfaces (i.e., the first surface 71b and the second surface 71c) of the negative current collecting foil 71. Meanwhile, the negative-electrode non-laminated part 70c is a portion of the negative electrode plate 70, in which the negative active material layer 73 is not laminated on any of the surfaces (i.e., the first surface 71b and the second surface 71c) of the negative current collecting foil 71, and is a portion only formed of the negative current collecting foil 71.

Each of the separators 80 includes a porous resin sheet, and a heat-resistant layer that is formed of heat-resistant particles and that is formed on the surface of the porous resin sheet. In the present embodiment, a porous resin sheet having a three layer structure in which a porous polyethylene layer is interposed between two porous polypropylene layers is used as the porous resin sheet. The nonaqueous electrolytic solution 90 contains an organic solvent (specifically, ethylene carbonate, ethyl methyl carbonate, and dimethyl carbonate), and LiPF₆. The wound electrode body 50 is formed such that the positive electrode plate 60, the negative electrode plate 70, and the separators 80 are wound in a state where the positive electrode laminated part 60b of the positive electrode plate 60 overlaps the negative electrode laminated part 70b of the negative electrode plate 70 through the separator 80 in the thickness direction DT (see FIG. 7).

In the positive electrode plate 60 of the present embodiment, an amount of AlF₃ per unit area is greater on surfaces (the first surface 61b and the second surface 61c) of each of the foil end portions 61f and 61g of the positive electrode laminated part 60b than on surfaces (the first surface 61b and the second surface 61c) of the foil central portion 61h of the positive electrode laminated part 60b. Therefore, a thickness of an AlF₃ coating (not shown) is greater on the surfaces of each of the foil end portions 61f and 61g of the positive electrode laminated part 60b than on the surfaces of the foil central portion 61h of the positive electrode laminated part 60b. In the battery 1 configured as above, corrosion resistance becomes higher on the surfaces of the foil end portions 61f and 61g of the positive electrode laminated part 60b than on the surface of the foil central portion 61h of the positive electrode laminated part 60b.

That is, in the battery 1 of the present embodiment, in the positive current collecting foil 61 included in the positive electrode laminated part 60b, corrosion resistance is selectively enhanced on the surfaces of the foil end portions 61f and 61g of the positive electrode laminated part 60b. On the surfaces of the foil end portions 61f and 61g of the positive electrode laminated part 60b, Al is likely to be eluted due to corrosion when high-load energization is performed at the initial use stage of the battery 1. Therefore, in the battery 1 of the present embodiment, elution of Al from the surface of the positive current collecting foil 61 in the case of high-load energization being performed at the initial use stage is reduced.

The foil end portion 61f of the positive electrode laminated part 60b is an end portion in the width direction DW (that is, the axial direction DX), which is a left end portion of the positive electrode laminated part 60b in FIG. 4, that occupies 10% of a range of the positive current collecting foil 61 included in the positive electrode laminated part 60b. That is, the foil end portion 61f is a portion that has a width dimension that is 10% of the width dimension of the positive current collecting foil 61 included in the positive electrode laminated part 60b. The foil end portion 61g, which is a right end portion of the positive electrode laminated part 60b in FIG. 4, of the positive electrode laminated part 60b also has the same width dimension as the foil end portion 61f (see FIG. 4). The foil central portion 61h of the positive electrode laminated part 60b also has the same width dimension as the foil end portion 61f.

The greater an amount of AlF₃ per unit area is on the surface of the positive current collecting foil 61 included in the positive electrode laminated part 60b, the lower a discharge capacity of the battery 1 tends to be. Therefore, for example, if an amount of AlF₃ per unit area is increased over the whole surface of the positive current collecting foil 61 included in the positive electrode laminated part 60b in order to enhance corrosion resistance, a discharge capacity of the lithium-ion secondary battery (hereinafter, simply referred to also as battery) may be significantly reduced.

Meanwhile, in the battery 1 of the present embodiment, an amount of AlF₃ per unit area is selectively increased at a portion that is likely to corrode when high-load energization is performed at the initial use stage of the battery 1, that is, at the surfaces (the first surface 61b and the second surface 61c) of the foil end portions 61f and 61g of the positive electrode laminated part 60b. Thus, reduction of a discharge capacity of the lithium-ion secondary battery can be made small as compared with a case where an amount of AlF₃ per unit area is increased over the whole surface of the positive current collecting foil 61 included in the positive electrode laminated part 60b.

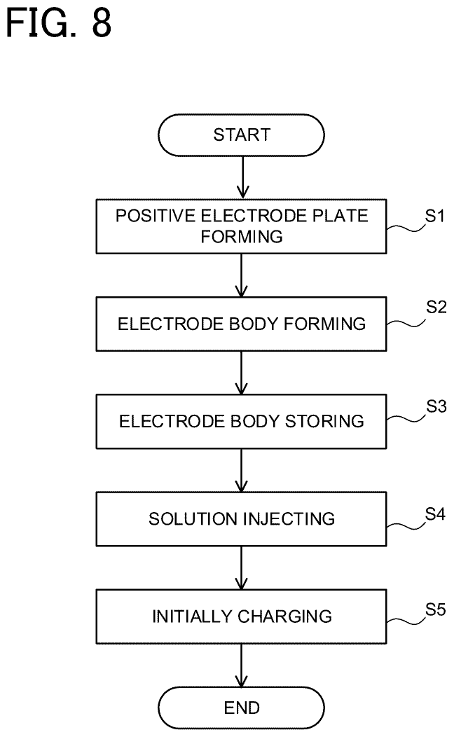

Next, a method for producing the battery 1 in the present embodiment will be described. FIG. 8 is a flow chart showing a flow of this method for producing the battery 1. Firstly, in step S1 (a positive electrode plate forming step), the positive electrode plate 60 including the positive active material layer 63 formed on the surfaces (the first surface 61b and the second surface 61c) of the positive current collecting foil 61is formed. Specifically, firstly, the positive active material particles 64, the binder 65, the conductive material 66, and a solvent (not shown) are mixed to form positive electrode paste 63P. Subsequently, the positive electrode paste 63P is applied to the first surface 61b of the strip-shaped positive current collecting foil 61 (specifically, a portion other than the positive current collecting foil 61 forming the positive-electrode non-laminated part 60c), to form a positive electrode paste layer 68 (see FIG. 4). In FIG. 4, reference characters of portions concerning the positive electrode paste layer 68 are indicated in parentheses.

Subsequently, a plurality of hydroxide particles 67 are supplied so as to be contained in both end portions 68f and 68g of the positive electrode paste layer 68. For example, powder (or mixture of the powder and a solvent) formed of the plurality of hydroxide particles 67 is applied to the surfaces of both the end portions 68f and 68g of the positive electrode paste layer 68. The end portion 68f of the positive electrode paste layer 68 is an end portion (a left end portion in FIG. 4) that occupies 10% of a range of the positive electrode paste layer 68 in the width direction DW (that is, the axial direction DX). That is, the end portion 68f of the positive electrode paste layer 68 is a portion that has a width dimension that is 10% of the width dimension of the positive electrode paste layer 68. The end portion 68g (right end portion in FIG. 4) of the positive electrode paste layer 68 also has the same width dimension as the end portion 68f (see FIG. 4). In the present embodiment, LiOH particles are used as the hydroxide particles 67.

Subsequently, the positive electrode paste layer 68 on the first surface 61b of the positive current collecting foil 61 is dried. Thus, the solvent evaporates from the positive electrode paste layer 68, and the positive active material layer 63 is formed on the first surface 61b of the positive current collecting foil 61 (see FIG. 4). In the positive active material layer 63 thus formed, the hydroxide particles 67 are contained only in positive active material layer end portions 63f and 63g that are both end portions of the positive active material layer 63, and the hydroxide particles 67 are not contained in the other portions. In the same manner, the positive active material layer 63 is formed also on the second surface 61c of the positive current collecting foil 61, and the positive electrode plate 60 formed of the positive electrode laminated part 60b and the positive-electrode non-laminated part 60c is formed (see FIG. 4). Also at the positive active material layer 63 on the second surface 61c, the hydroxide particles 67 are contained only in the positive active material layer end portions 63f and 63g that are both the end portions of the positive active material layer 63, and the hydroxide particles 67 are not contained in the other portions.

As described above, in the positive electrode plate forming step of the present embodiment, the hydroxide particles 67 are supplied so as to be contained only in the positive active material layer end portions 63f and 63g existing on the surfaces (the first surface 61b and the second surface 61c) of the foil end portions 61f and 61g, respectively, of the positive electrode laminated part 60b, in the positive active material layer 63. The positive active material layer end portions 63f and 63g are the end portions each of which occupies 10% of the range of the positive active material layer 63 in the width direction DW (that is, the axial direction DX). The first surface 61b and the second surface 61c of the positive current collecting foil 61 (aluminum foil) used in step S1 (positive electrode plate forming step) are each covered with an Al₂O₃ coating that is an oxide film.

Thereafter, in step S2 (an electrode body forming step), the wound electrode body 50 is formed by winding the positive electrode plate 60, the negative electrode plate 70, and the separators 80 so that the separators 80 are alternately interposed between the positive electrode plate 60 and the negative electrode plate 70 (see FIG. 7).

Subsequently, in step S3 (a storage step), the wound electrode body 50 is stored inside the battery case 30. Specifically, firstly, the lid 11 is prepared, and the positive terminal member 41 and the negative terminal member 45 are fixed to the lid 11. Thereafter, the positive terminal member 41 fixed to the lid 11 and the positive electrode plate 60 included in the wound electrode body 50 are connected to each other. Specifically, the positive terminal member 41 and the positive-electrode non-laminated part 60c of the positive electrode plate 60 included in the wound electrode body 50 are welded together. Furthermore, the negative terminal member 45 fixed to the lid 11 and the negative electrode plate 70 included in the wound electrode body 50 are connected to each other. Specifically, the negative terminal member 45 and the negative-electrode non-laminated part 70c of the negative electrode plate 70 included in the wound electrode body 50 are welded together. Thus, the lid 11 and the wound electrode body 50 are integrated through the positive terminal member 41 and the negative terminal member 45.

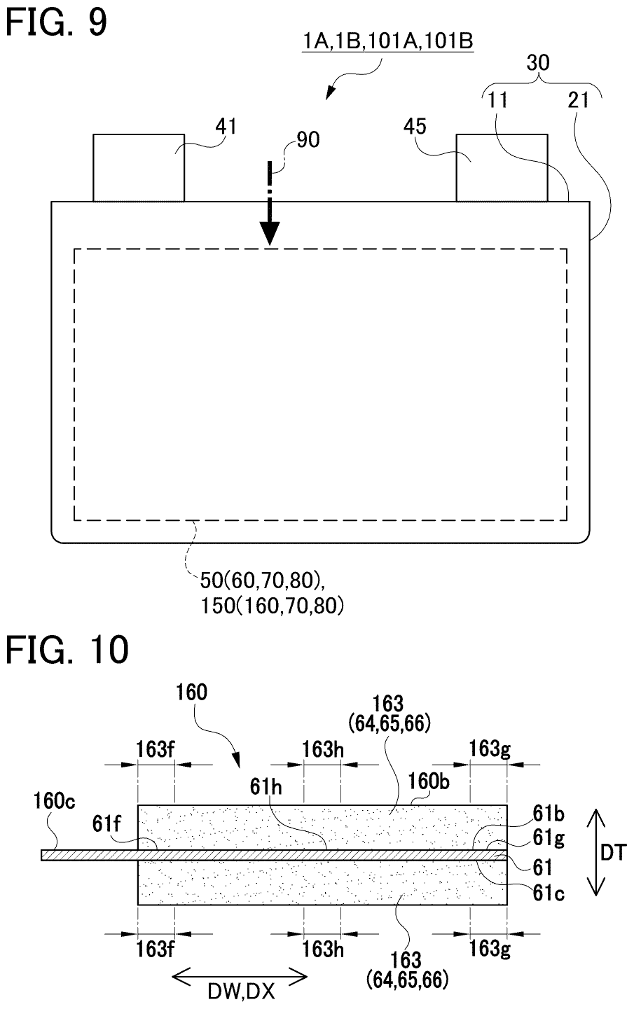

Subsequently, the wound electrode body 50 integrated with the lid 11 is stored inside the case body 21, and the opening of the case body 21 is closed by the lid 11. In this state, the lid 11 and the case body 21 are welded to each other over their entire circumference. Thus, the case body 21 and the lid 11 are joined to each other to complete the battery case 30, and a battery 1A having been assembled is produced (see FIG. 9). This battery 1A having been assembled (hereinafter, also simply referred to as the assembled battery 1A), is a structure in which the battery case 30, the wound electrode body 50, the positive terminal member 41, and the negative terminal member 45 are assembled. Specifically, the assembled battery 1A includes the battery case 30, the wound electrode body 50 stored inside the battery case 30, and the positive terminal member 41 and the negative terminal member 45 connected to the wound electrode body 50.

Subsequently, in step S4 (a solution injecting step), the nonaqueous electrolytic solution 90 is injected into the battery case 30 storing the wound electrode body 50, and a battery 1B into which the solution has been injected (hereinafter, also simply referred to as a solution-injected battery 1B) is produced (see FIG. 9). Specifically, the lid 11 of the battery case 30 of the assembled battery 1A has a not-illustrated liquid inlet formed therein. The nonaqueous electrolytic solution 90 is injected through the liquid inlet into the battery case 30 of the assembled battery 1A. Thus, the nonaqueous electrolytic solution 90 is impregnated into the wound electrode body 50, and the nonaqueous electrolytic solution 90 is accumulated on the bottom surface side in the battery case 30. Thereafter, the liquid inlet is sealed, and thus the solution-injected battery 1B is produced.

Subsequently, in step S5 (an initial charging step), initial charging is performed for the solution-injected battery 1B. Thus, this solution-injected battery 1B is activated, and the battery 1 is obtained. In the initial charging step of the present embodiment, constant current charging for the solution-injected battery 1B is performed at a constant current value of 0.2 C until the battery voltage value of the solution-injected battery 1B reaches 4.1 V. Thereafter, the battery 1 having been subjected to the initial charging is tested, and the battery 1 is thus completed and is ready to be delivered.

In the production method of the present embodiment, in the positive electrode plate forming step (step S1), the hydroxide particles 67 are supplied so as to be contained only in the positive active material layer end portions 63f and 63g existing on the surfaces of the foil end portions 61f and 61g, respectively, of the positive electrode laminated part 60b, in the positive active material layer 63. Thus, this method can produce the battery 1 in which an amount of AlF₃ per unit area is greater on the surfaces of each of the foil end portions 61f and 61g of the positive electrode laminated part 60b than on the surfaces of the foil central portion 61h of the positive electrode laminated part 60b. Thus, in a case where the hydroxide particles 67 are contained in the positive active material layer 63, an AlF₃ coating having high corrosion resistance is easily formed on the surface (the first surface 61b and the second surface 61c) of the positive current collecting foil 61.

Specifically, in a period from after the nonaqueous electrolytic solution 90 is injected into the battery case 30 storing therein the wound electrode body 50 having the positive electrode plate 60 and others until the battery 1 is completed and is ready to be delivered, a series of the following reactions (a) to (c) is caused at a portion of the positive electrode plate 60 in which the hydroxide particles 67 are contained, and an AlF₃ coating generation reaction is thus promoted on the surface of the positive current collecting foil 61. Particularly, in the initial charging step (step S5), the AlF₃ coating generation reaction is promoted. Therefore, the production method of the present embodiment enables production of the battery 1 in which an amount of AlF₃ per unit area is greater on the surfaces of each of the foil end portions 61f and 61g of the positive electrode laminated part 60b than on the surfaces of the foil central portion 61h of the positive electrode laminated part 60b.

(a) LiOH in the positive active material layer end portions 63f and 63g is decomposed to generate H₂O.

2LiOH→Li₂O+H₂O (Formula 6)

(b) The generated H₂O reacts with LiPF₆ in the nonaqueous electrolytic solution 90 to generate HF.

LiPF₆+H₂O→LiF+POF₃+2HF (Formula 7)

(c) The generated HF reacts with Al₂O₃ coatings on the surfaces of the foil end portions 61f and 61g of the positive electrode laminated part 60b to generate AlF₃ coatings on the surfaces of the foil end portions 61f and 61g of the positive electrode laminated part 60b.

Al₂O₃+6HF→2AlF₃+3H₂O (Formula 8)

As described above, Al is easily eluted due to corrosion on the surfaces of the foil end portions 61f and 61g of the positive electrode laminated part 60b, in the positive current collecting foil 61 included in the positive electrode laminated part 60b, when high-load energization is performed at the initial use stage of the battery. Therefore, the production method of the present embodiment can produce the lithium-ion secondary battery 1 which allows reduction of elution of Al from the surface of the positive current collecting foil 61 in the case of high-load energization being performed at the initial use stage.

### Examples 1 to 5

In Examples 1 to 5, in step S1 (the positive electrode plate forming step), a proportion of the hydroxide particles 67 to components other than the hydroxide particles 67 in the positive active material layer end portions 63f and 63g, which is hereinafter also simply referred to as a proportion of the hydroxide particles 67, were made different. Specifically, in Examples 1 to 5, a weight ratio between the hydroxide particles 67, and the components other than the hydroxide particles 67 in the positive active material layer end portions 63f and 63g, was made different. The batteries 1 of Examples 1 to 5 were produced in the same manner except for the weight ratio. Specifically, the proportion of the hydroxide particles 67 was 0.1 wt % in Example 1. The proportion of the hydroxide particles 67 was 0.5 wt % in Example 2. The proportion of the hydroxide particles 67 was 1.0 wt % in Example 3. The proportion of the hydroxide particles 67 was 3.0 wt % in Example 4. The proportion of the hydroxide particles 67 was 5.0 wt % in Example 5.

### Comparative Example 1

In Comparative example 1, the proportion of the hydroxide particles 67 was 0 wt %. Specifically, in Comparative example 1, a positive electrode plate that did not contain the hydroxide particles 67 was produced. A lithium-ion secondary battery of Comparative example 1 was produced in the same manner as in Example 1 except for the proportion of the hydroxide particles 67.

### Examination of AlF₃ Coating on Positive Current Collecting Foil

Subsequently, for the battery of each of Examples 1 to 5 and Comparative example 1, an AlF₃ coating on the surface of the positive current collecting foil was examined. Each of the batteries to be examined was a battery having been just completed and being ready to be delivered, and was an unused one, that is, a new one.

Specifically, each battery was disassembled, and the positive electrode plate was taken out. The positive electrode plate having been taken out was immersed in ethyl methyl carbonate for ten minutes, and thereafter dried, and components of the nonaqueous electrolytic solution 90 adhered to the positive electrode plate were removed. Thereafter, the positive active material layer was peeled from the positive current collecting foil 61 of the positive electrode plate, and the first surface 61b and the second surface 61c of the positive current collecting foil 61 were exposed. These first surface 61b and second surface 61c were analyzed by SEM-EDX (energy dispersive X-ray spectroscopy), and a ratio (F/Al) of F element to Al element was calculated. Specifically, for the foil end portions 61f and 61g and the foil central portion 61h of the positive electrode laminated part 60b, an (F/Al) value was calculated. It can be considered that the greater the (F/Al) value was, the greater an amount of AlF 3 per unit area was.

According to the results of the examination, in the battery of Comparative example 1, the (F/Al) value was the same between the surfaces of each of the foil end portions 61f and 61g of the positive electrode laminated part 60b and the surfaces of the foil central portion 61h of the positive electrode laminated part 60b. Meanwhile, in the battery of each of Examples 1 to 5, the (F/Al) value was greater on the surfaces of each of the foil end portions 61f and 61g of the positive electrode laminated part 60b than on the surfaces of the foil central portion 61h of the positive electrode laminated part 60b. Therefore, an amount of AlF₃ per unit area and the thickness of the AlF₃ coating were greater on each of the surfaces of the foil end portions 61f and 61g of the positive electrode laminated part 60b than on the surfaces of the foil central portion 61h of the positive electrode laminated part 60b. In the battery 1 having such a configuration, the surfaces of the foil end portions 61f and 61g of the positive electrode laminated part 60b have higher corrosion resistance than the surfaces of the foil central portion 61h of the positive electrode laminated part 60b.

More specifically, in each of Examples 1 to 5, although the (F/Al) value at the foil central portion 61h of the positive electrode laminated part 60b was the same as that in Comparative example 1, the (F/Al) value at each of the foil end portions 61f and 61g of the positive electrode laminated part 60b was greater than that in Comparative example 1. According to this result, in a case where the hydroxide particles 67 were contained in the positive active material layer end portions 63f and 63g of the positive active material layer 63, formation of the AlF₃ coatings on the surfaces of the foil end portions 61f and 61g of the positive electrode laminated part 60b was promoted, and corrosion resistance of the surfaces of the foil end portions 61f and 61g of the positive electrode laminated part 60b was able to be enhanced.

### High-Load Energization Test

Subsequently, for the battery of each of Examples 1 to 5 and Comparative example 1, a high-load energization test was performed. Each of the batteries used in this test was a battery having been just completed and having entered a delivery waiting state, and was an unused one (that is, a new one). Therefore, in each of the batteries used in this test, high-load energization in this test was high-load energization at the initial use stage.

In this test, the following charging and discharging cycle was set as one cycle, and 20 cycles of charging and discharging were performed in a temperature environment of 25° C. for each battery. Specifically, the charging and discharging cycle was as follows. Firstly, discharging was performed at a current value of 0.2 C until the battery voltage value reached 3.5 V. Thereafter, no operation was performed for ten minutes. Thereafter, charging was performed at a current value of 1 C until the battery voltage value reached 4.0 V. Thereafter, no operation was performed for ten minutes. This charging and discharging cycle was set as one cycle and 20 cycles of the charging and discharging were performed.

For each battery, after the above-described charging and discharging cycle was performed for 20 cycles, whether or not Al was eluted from the first surface 61b and the second surface 61c of the positive current collecting foil 61 was checked. Specifically, after the charging and discharging cycle was performed for 20 cycles, each battery was disassembled and the positive electrode plate was taken out. The positive electrode plate having been taken out was immersed in ethyl methyl carbonate for ten minutes, and thereafter dried, and components of the nonaqueous electrolytic solution 90 adhered to the positive electrode plate were removed. Thereafter, the positive active material layer was peeled from the positive current collecting foil 61 of the positive electrode plate, and the first surface 61b and the second surface 61c of the positive current collecting foil 61 were exposed. The first surface 61b and the second surface 61c of the positive current collecting foil 61 were observed by a microscope, and presence or absence of pitting corrosion was confirmed. The pitting corrosion was caused by elution of Al from the first surface 61b and the second surface 61c of the positive current collecting foil 61. Therefore, whether or not Al was eluted was able to be determined according to presence or absence of the pitting corrosion. Table 1 indicates the results. In Table 1, evaluation was made according to three grades of A (good), B (fair), and C (poor) in batteries(cells) for “Al pitting corrosion”.

TABLE 1

| | hydroxide | Al pitting | Discharge |
|---|---|---|---|
| | particles (wt %) | corrosion | capacity |
| Example 1 | 0.1 | B | A |
| Example 2 | 0.5 | A | A |
| Example 3 | 1.0 | A | A |
| Example 4 | 3.0 | A | A |
| Example 5 | 5.0 | A | A |
| Comparative example 1 | 0 | C | A |

As indicated in Table 1, in Examples 2 to 5, the Al pitting corrosion was evaluated as A (good), and pitting corrosion was absent at the first surface 61b and the second surface 61c of the positive current collecting foil 61. According to the results, in the battery 1 of each of Examples 2 to 5, it was possible to prevent elution of Al from the first surface 61b and the second surface 61c of the positive current collecting foil 61 in the case of high-load energization being performed at the initial use stage. Therefore, the battery 1 of each of Examples 2 to 5 is considered to be a battery in which Al is unlikely to be eluted from the first surface 61b and the second surface 61c of the positive current collecting foil 61 when high-load energization is performed at the initial use stage.

Meanwhile, in Comparative example 1, the Al pitting corrosion was evaluated as C (poor), and a lot of pitting corrosion was present at the first surface 61b and the second surface 61c of the positive current collecting foil 61. Specifically, a lot of pitting corrosion was present at the foil end portions 61f and 61g of the positive electrode laminated part 60b. Therefore, the battery of Comparative example 1 is considered to be a battery in which Al is likely to be eluted from the first surface 61b and the second surface 61c of the positive current collecting foil 61 when high-load energization is performed at the initial use stage.

In Example 1, Al pitting corrosion was evaluated as B (fair), and pitting corrosion was present at the foil end portions 61f and 61g of the positive electrode laminated part 60b. However, the number of portions in which pitting corrosion was present was small and the size of the pitting corrosion was also small as compared with Comparative example 1. According to this result, in the battery 1 of Example 1, elution of Al from the first surface 61b and the second surface 61c of the positive current collecting foil 61 in the case of high-load energization being performed at the initial use stage was able to be reduced as compared with the battery of Comparative example 1. Therefore, in the battery 1 of Example 1, Al is less likely to be eluted from the first surface 61b and the second surface 61c of the positive current collecting foil 61 when high-load energization is performed at the initial use stage, as compared with the battery of Comparative example 1.

### Discharge Capacity Measuring Test

For the battery of each of Examples 1 to 5 and Comparative example 1, a discharge capacity was measured. Specifically, firstly, each battery was charged at a current value of 0.2 C until the battery voltage value reached 4.2 V. Thereafter, the battery was charged while the battery voltage value was maintained at 4.2 V until the SOC became 100%. Thereafter, the battery was discharged at a current value of 0.2 C until the battery voltage value reached 3.0 V. Thereafter, the battery was discharged while the battery voltage value was maintained at 3.0 V until the SOC became 0%. At this time, an amount of discharged electricity in a period from the SOC of 100% to the SOC of 0% was measured as a discharge capacity of each battery. The value of the discharge capacity of each battery was evaluated. Table 1 indicates the results.

As indicated as A (good) in Table 1, the battery of each of Examples 1 to 5 and Comparative example 1 could have a sufficient discharge capacity. Specifically, the discharge capacity of the battery of Comparative example 1 was highest, and the higher the proportion (wt %) of the hydroxide particles 67 (specifically, LiOH) was, the lower the discharge capacity was, in the produced batteries. Specifically, although the discharge capacity of the battery of each of Examples 1 to 5 was less than the discharge capacity of the battery of Comparative example 1, the reduced amount was small.

According to the above-described test results, in a case where the hydroxide particles 67 are contained in the positive active material layer end portions 63f and 63g, elution of Al from the positive current collecting foil 61 can be reduced. Furthermore, the proportion of the hydroxide particles 67 to the components other than the hydroxide particles 67 in the positive active material layer end portions 63f and 63g is considered to be more preferably 0.5 wt % or higher. Thus, the AlF₃ coating is more easily formed on the surfaces of the foil end portions 61f and 61g of the positive electrode laminated part 60b, and elution of Al from the surfaces of the foil end portions 61f and 61g of the positive electrode laminated part 60b can be prevented.

### Modified Embodiment

Next, a modified embodiment of the present disclosure will be described. Differences from the foregoing embodiment will be mainly described below, and description of the same matter as for the embodiment will be omitted or simplified. A lithium-ion secondary battery 101 (hereinafter, also simply referred to as a battery 101) in the modified embodiment is different from the battery 1 in the foregoing embodiment only in that a positive electrode plate 160 forming a wound electrode body 150 is used in the battery 101, and the other configurations are the same therebetween (see FIGS. 1 and 2). The positive electrode plate 160 is different from the positive electrode plate 60 of the embodiment only in that a positive active material layer 163 is used in the positive electrode plate 160, and the other configurations are the same therebetween. The positive active material layer 163 is different from that of the positive electrode plate 60 of the embodiment in that the positive active material layer 163 does not contain the hydroxide particles 67. The positive electrode plate 160 also has a positive electrode laminated part 160b and a positive-electrode non-laminated part 160c, similarly to the positive electrode plate 60 of the embodiment (see FIGS. 3 and 10).

Also in the positive electrode plate 160 of the modified embodiment, an amount of AlF₃ per unit area is greater on the surfaces (i.e., the first surface 61b and the second surface 61c) of each of the foil end portions 61f and 61g of the positive electrode laminated part 160b than on the surfaces (i.e., the first surface 61b and the second surface 61c) of the foil central portion 61h of the positive electrode laminated part 160b. Therefore, an AlF₃ coating (not shown) has a greater thickness on the surfaces of each of the foil end portions 61f and 61g of the positive electrode laminated part 160b than on the surfaces of the foil central portion 61h of the positive electrode laminated part 160b. Therefore, corrosion resistance is higher on the surfaces of the foil end portions 61f and 61g of the positive electrode laminated part 160b than on the surfaces of the foil central portion 61h of the positive electrode laminated part 160b. Therefore, also in the battery 101 of the modified embodiment, elution of Al from the surface of the positive current collecting foil 61 in the case of high-load energization being performed at the initial use stage is reduced.

Furthermore, as described above, in the battery 101 of the modified embodiment, an amount of AlF₃ per unit area is selectively increased at a portion that is likely to corrode when high-load energization is performed at the initial use stage of the battery 101, that is, on the surfaces of the foil end portions 61f and 61g of the positive electrode laminated part 160b. Thus, reduction of a discharge capacity of the battery can be made smaller as compared with a case where an amount of AlF₃ per unit area is increased over the whole surface of the positive current collecting foil 61 included in the positive electrode laminated part 160b.

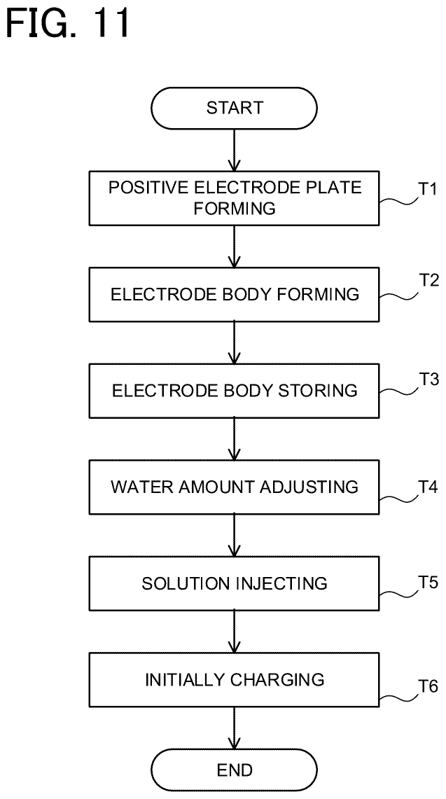

Next, a method for producing the battery 101 in the modified embodiment will be described. FIG. 11 is a flow chart showing a flow of the method for producing the battery 101. Firstly, in step T1 (a positive electrode plate forming step), the positive electrode plate 160 including the positive active material layer 163 is formed on the surfaces (the first surface 61b and the second surface 61c) of the positive current collecting foil 61. Step T1 is different from Step T1 in the embodiment only in that hydroxide particles 67 are not supplied, and others are the same. Thereafter, in step T2 (an electrode body forming step), the wound electrode body 150 is formed by winding the positive electrode plate 160, the negative electrode plate 70, and the separators 80 in the same manner as in step S2 of the embodiment (see FIG. 7). Subsequently, in step T3 (a storage step), in the same manner as in step S3 of the embodiment, the wound electrode body 150 is stored inside the battery case 30 and a battery 101A having been assembled is produced (see FIG. 9).

Subsequently, in step T4 (a water amount adjustment step), an amount of water (water content) at each of positive active material layer end portions 163f and 163g is adjusted to be equal to or higher than 100 ppm, and an amount of water (i.e., a water content) at a positive active material layer central portion 163h is adjusted to be less than the amount of water in each of the positive active material layer end portions 163f and 163g. Each of the positive active material layer end portions 163f and 163g is an end portion that occupies 10% of a range of the positive active material layer 163 in the width direction DW (that is, the axial direction DX). The positive active material layer central portion 163h is a portion located at the central portion of the positive active material layer 163 in the width direction DW (that is, the axial direction DX), and occupies 10% of a range of the positive active material layer 163 in the width direction DW (see FIG. 10).

Specifically, firstly, the battery 101A having been assembled, which is also simply referred to as the assembled battery 101A, is heated and dried at a temperature of 110° C. for two hours. the lid 11 of the assembled battery 101A is formed with a not-illustrated liquid inlet. Therefore, when the assembled battery 101A is heated and dried, at least a part of the water in the wound electrode body 150 evaporates through the liquid inlet to the outside. Thus, an amount of water contained in the positive active material layer 163 can be reduced over the whole positive active material layer 163. Through this heating and drying process, an amount of water in the positive active material layer 163 is adjusted to be less than 100 ppm. Specifically, an amount of water in the positive active material layer 163 has almost the same value (specifically, 65 to 68 ppm) over the whole positive active material layer 163.

Thereafter, the assembled battery 101A is left standing in an environment of 25° C. and 25% RH for a predetermined time period (for example, 30 minutes), and the positive active material layer end portions 163f and 163g are thus allowed to absorb water, and an amount of water in each of the positive active material layer end portions 163f and 163g is adjusted to be equal to or higher than 100 ppm. Specifically, the assembled battery 101A is stored in a thermohygrostat bath retained at a temperature of 25° C. and a humidity of 25% RH for a predetermined time period. Thus, water enters the assembled battery 101A through the liquid inlet, and the water permeates the wound electrode body 150 from both end portions of the wound electrode body 150 in the axial direction DX. Therefore, increase of an amount of water is more difficult at the positive active material layer central portion 163h than at the positive active material layer end portions 163f and 163g. Accordingly, an amount of water in the positive active material layer central portion becomes less than an amount of water in the positive active material layer end portion. Thus, an amount of water in each of the positive active material layer end portions 163f and 163g is equal to or higher than 100 ppm, and an amount of water in the positive active material layer central portion 163h is less than the amount of water in each of the positive active material layer end portions 163f and 163g.

Subsequently, in step T5 (a solution injecting step), in the same manner as in step S4 of the embodiment, the nonaqueous electrolytic solution 90 is injected into the assembled battery 101A, and a battery 101B into which the solution has been injected (hereinafter, also simply referred to as a solution-injected battery 101B) is produced (see FIG. 9). However, in the modified embodiment, in the previous step T4, the wound electrode body 150 of the assembled battery 101A needs to satisfy the following two conditions of (d) and (e). One condition (d) is that an amount of water in each of the positive active material layer end portions 163f and 163g of the positive active material layer 163, existing on the surfaces of the foil end portions 61f and 61g of the positive electrode laminated part 160b, is 100 ppm or higher. The other condition (e) is that an amount of water in the positive active material layer central portion 163h of the positive active material layer 163, existing on the surface of the foil central portion 61h of the positive electrode laminated part 160b, is less than the amount of water in each of the positive active material layer end portions 163f and 163g. Therefore, in step T5 (the solution injecting step), the nonaqueous electrolytic solution 90 can be injected into the battery case 30 that stores the wound electrode body 150 satisfying the two conditions of (d) and (e).

Subsequently, in step T6 (an initial charging step), in the same manner as in step S5 of the embodiment, the solution injected battery 101B into which the nonaqueous electrolytic solution 90 has been injected (hereinafter, also simply referred to as the solution-injected battery 101B) is subjected to initial charging. Thus, the solution-injected battery 101B is activated, and the battery 101 is obtained. Thereafter, the battery 101 having been subjected to the initial charging is tested, and the battery 101 is thus completed and is ready to be delivered.

In the modified embodiment, in step T5 (the solution injecting step), the nonaqueous electrolytic solution 90 is injected into the battery case 30 that stores the wound electrode body 150 satisfying the two conditions of (d) and (e). Thus, the battery 101 can be produced, in which an amount of AlF₃ per unit area is greater on each of the surfaces of the foil end portions 61f and 61g of the positive electrode laminated part 160b than on the surface of the foil central portion 61h of the positive electrode laminated part 160b. This is because the greater an amount of water in the positive active material layer 163 is when the solution injecting step is performed, the more easily an AlF₃ coating having high corrosion resistance is formed on the surface of the positive current collecting foil 61 in a period from after injection of the nonaqueous electrolytic solution 90 into the battery case 30 to delivery of the battery 101. Particularly, in a case where the solution injecting step is performed in a state where an amount of water in the positive active material layer 163 is equal to or higher than 100 ppm, an AlF₃ coating having high corrosion resistance is easily formed on the surface of the positive current collecting foil 61 in the period from after injection of the nonaqueous electrolytic solution 90 into the battery case 30 to delivery of the battery 101. Specifically, in the initial charging step, an AlF₃ coating generation reaction is promoted, and corrosion resistance becomes high on the surface of the positive current collecting foil 61. Therefore, the production method in the modified embodiment can produce the battery 101 which allows reduction of elution of Al from the surface of the positive current collecting foil 61 in the case of high-load energization being performed at the initial use stage.

In the production method in the modified embodiment, an AlF₃ coating having high corrosion resistance is formed on the surface of the positive current collecting foil 61 through a series of the following reactions (f) and (g). The surface of the positive current collecting foil used in the positive electrode plate forming step is covered with an Al₂O₃ coating that is an oxide film. Therefore, the surface of the positive current collecting foil 61 in the wound electrode body 150 used in the solution injecting step is also covered with an Al₂O₃ coating.

(f) After the nonaqueous electrolytic solution 90 is injected into the battery case 30 in the solution injecting step, H₂O contained in the positive electrode plate 160 in the battery case 30 reacts with LiPF₆ in the nonaqueous electrolytic solution 90 to generate HF.

LiPF₆+H₂O→LiF+POF₃+2HF (Formula 9)

(g) The generated HF reacts with an Al₂O₃ coating on the surface of the positive current collecting foil 61 to generate an AlF₃ coating on the surface of the positive current collecting foil 61.

Al₂O₃+6HF→2AlF₃+3H₂O (Formula 10)

### Modified Examples 1 to 3

In Modified examples 1 to 3, a time for leaving the assembled battery 101A to stand in an environment of 25° C. and 25% RH in step T4 (the water amount adjustment step), which is hereinafter also referred to as a moisture absorption time, was made different among Modified examples 1 to 3 so that an amount of water in the positive active material layer end portions 163f and 163g was different among Modified examples 1 to 3. Thus, the assembled batteries 101A in Modified examples 1 to 3 to be subjected to step T5 (the solution injecting step) were different from each other in the amount of water in the positive active material layer end portions 163f and 163g. The batteries 101 in Modified examples 1 to 3 were produced in the same manner except for the amount of water. An amount of water in the positive active material layer 163 in each Modified example was measured by a known Karl Fischer moisture meter.

Specifically, in Modified examples 1 to 3, the times (the moisture absorption time in Table 2) for leaving the assembled battery 101A to stand in an environment of 25° C. and 25% RH were five minutes, 30 minutes, and 120 minutes in Modified examples 1 to 3, respectively (see Table 2). Thus, an amount of water in the positive active material layer end portions 163f and 163g was different among Modified examples 1 to 3. Specifically, in Modified examples 1 to 3, in step T4 (the water amount adjustment step), the amounts of water in the positive active material layer end portions 163f and 163g were 110 ppm, 230 ppm, and 295 ppm in Modified examples 1 to 3, respectively (see Table 2).

TABLE 2

| | Moisture adsorption | Amount of water | Amount of water | A1 pitting | Discharge |
|---|---|---|---|---|---|
| | time (min) | in XX (ppm) | in YY (ppm) | corrosion | capacity |
| Modified Example 1 | 5 | 110 | 73 | A | A |
| Modified Example 2 | 30 | 230 | 90 | A | A |
| Modified Example 3 | 120 | 295 | 144 | A | B |
| Comparative Example 2 | 0 | 68 | 65 | C | A |

XX: positive active material layer end portion
YY: positive active material layer central portion

### Comparative Example 2

In Comparative example 2, the assembled battery 101A was only heated and dried at a temperature of 110ºC for two hours in step T4 (the water amount adjustment step), and step T5 (the solution injecting step) was thereafter performed without leaving the assembled battery 101A to stand in an environment of 25° C. and 25% RH. In Comparative example 2, in step T4, an amount of water in each of the positive active material layer end portions 163f and 163g was 68 ppm (see Table 2). The battery of Comparative example 2 was produced in the same manner as in Modified example 1 except for step T4.

### Examination of AlF₃ Coating of Positive Current Collecting Foil

Subsequently, for the battery of each of Modified examples 1 to 3 and Comparative example 2, an AlF₃ coating on the surface of the positive current collecting foil 61 was examined in the same manner as in Example 1. Each of the batteries to be examined was a battery having been just completed and being ready to be delivered, and was an unused one.

In Comparative example 2, the (F/Al) value was the same between the surfaces of each of the foil end portions 61f and 61g of the positive electrode laminated part 160b and the surfaces of the foil central portion 61h of the positive electrode laminated part 160b. Meanwhile, in Modified examples 1 to 3, the (F/Al) value was greater on the surfaces of each of the foil end portions 61f and 61g of the positive electrode laminated part 160b than on the surfaces of the foil central portion 61h of the positive electrode laminated part 160b. Therefore, an amount of AlF₃ per unit area and the thickness of the AlF₃ coating were greater on each of the surfaces of the foil end portions 61f and 61g of the positive electrode laminated part 160b than on the surface of the foil central portion 61h of the positive electrode laminated part 160b.

More specifically, in Modified examples 1 to 3, the (F/Al) value in each of the foil end portions 61f and 61g of the positive electrode laminated part 160b was greater than that in Comparative example 2. According to the results, when the nonaqueous electrolytic solution 90 was injected in the solution injecting step (step T5) into the battery case 30 that stored the wound electrode body 50 in which an amount of water in each of the positive active material layer end portions 163f and 163g was equal to or higher than 100 ppm, formation of AlF₃ coatings on the surfaces of the foil end portions 61f and 61g of the positive electrode laminated part 160b was thereafter promoted, and corrosion resistance of the surfaces of the foil end portions 61f and 61g of the positive electrode laminated part 160b was able to be enhanced.

### High-Load Energization Test

Subsequently, for the battery of each of Modified examples 1 to 3 and Comparative example 2, the high-load energization test was performed in the same manner as in Example 1. Each of the batteries used in this test was a battery having been just completed and being ready to be delivered, and was an unused one, that is, a new one. Therefore, in each of the batteries used in this test, high-load energization in this test was high-load energization at the initial use stage. In this test, similarly to Example 1, each battery was subjected to 20 cycles of the charging and discharging, and whether or not Al was eluted from the first surface 61b and the second surface 61c of the positive current collecting foil 61 was thereafter checked. Whether or not Al was eluted was determined according to presence or absence of pitting corrosion in the positive current collecting foil 61, similarly to Example 1. Table 2 indicates the results.

As indicated in Table 2, in Modified examples 1 to 3, the Al pitting corrosion was evaluated as A (good), and pitting corrosion was absent in the first surface 61b and the second surface 61c of the positive current collecting foil 61. According to this result, in the battery 101 of each of Modified examples 1 to 3, elution of Al from the first surface 61b and the second surface 61c of the positive current collecting foil 61 in the high-load energization performed at the initial use stage was able to be prevented. Meanwhile, in Comparative example 2, the Al pitting corrosion was evaluated as C (poor), and a lot of pitting corrosion was present in the first surface 61b and the second surface 61c of the positive current collecting foil 61. Specifically, a lot of pitting corrosion was present in the foil end portions 61f and 61g of the positive electrode laminated part 160b. Therefore, in the battery of Comparative example 2, Al was likely to be eluted from the first surface 61b and the second surface 61c of the positive current collecting foil 61 when high-load energization was performed at the initial use stage.

### Discharge Capacity Measuring Test

Furthermore, for the battery of each of Modified examples 1 to 3 and Comparative example 2, a discharge capacity was measured in the same manner as in Example 1. Table 2 indicates the results. As indicated as A (good) in Table 2, the battery of each of Modified examples 1, 2 and Comparative example 2 could have a sufficient discharge capacity. Specifically, the discharge capacity of the battery of Comparative example 2 was highest, and the greater an amount of water in the positive active material layer end portions 163f and 163g was when the solution injecting step was performed, the lower the discharge capacity was. Specifically, the discharge capacity of the battery of each of Modified examples 1, 2 was less than the discharge capacity of the battery of Comparative example 2. However, the reduced amount was small.

Meanwhile, in the battery of Modified example 3, as indicated as B (fair) in Table 2, the discharge capacity of the battery of Modified example 3 was less than the discharge capacity of the battery of Comparative example 2, and the reduced amount was greater as compared with the lithium-ion secondary battery of each of Modified examples 1, 2. According to the above-described results, it was found that the greater an amount of water in the positive active material layer end portions 163f and 163g was when the solution injecting step was performed, the lower the discharge capacity of the battery was, and reduction of the discharge capacity of the battery was great when the amount of water was equal to or higher than 290 ppm.

According to the above-described results, an amount of water in each of the positive active material layer end portions 163f and 163g is more preferably 100 ppm or higher but 290 ppm or less when the solution injecting step is performed. This can reduce elution of Al from the surface of the positive current collecting foil 61 in the case of high-load energization being performed at the initial use stage of the battery, and thus suppress reduction of the discharge capacity of the battery.

In Modified examples 1 to 3, an amount of water in the positive active material layer central portion 163h was less than the amount of water in each of the positive active material layer end portions 163f and 163g when the solution injecting step was performed (see Table 2). Thus, reduction of the discharge capacity of the lithium-ion secondary battery can be made small as compared with a case where an amount of water in the positive active material layer central portion 163h is equal to an amount of water in each of the positive active material layer end portions 163f and 163g when the solution injecting step is performed.

The present disclosure has been described above in the embodiment and the modified embodiment. However, the present disclosure is not limited to the above-described embodiment, and it is needless to say that modified embodiment can be made as appropriate without departing from the gist of the present disclosure.

What is claimed is:

1. A lithium-ion secondary battery comprising:
a wound electrode body including a strip-shaped positive electrode plate, a strip-shaped negative electrode plate, and a strip-shaped separator, which are wound so that the separator is interposed between the positive electrode plate and the negative electrode plate;
a nonaqueous electrolytic solution containing LiPF₆; and
a battery case in which the wound electrode body and the nonaqueous electrolytic solution are stored,
wherein the positive electrode plate includes a positive current collecting foil formed of an aluminum foil, and a positive active material layer laminated on a surface of the positive current collecting foil, and
the positive electrode plate is configured such that:
a positive electrode laminated part is defined by a portion in which the positive active material layer is laminated on the surface of the positive current collecting foil, and
the positive electrode laminated part includes:
current collecting foil end portions, which are end portions of the positive current collecting foil included in the positive electrode laminated part, the end portions being located at both ends of the positive electrode laminated part in an axial direction of the wound electrode body; and
a current collecting foil central portion, which is a central portion of the positive current collecting foil included in the positive electrode laminated part, the central portion being located at a center of the positive electrode laminated part in the axial direction of the wound electrode body, and
an amount of AlF₃ per unit area is greater on each of surfaces of the current collecting foil end portions of the positive electrode laminated part than on a surface of the current collecting foil central portion of the positive electrode laminated part.

2. A method for producing the lithium-ion secondary battery according to claim 1, the method comprising:
forming the positive electrode plate including the positive active material layer on the surface of the positive current collecting foil;
forming the wound electrode body by winding the positive electrode plate, the negative electrode plate, and the separator so that the separator is interposed between the positive electrode plate and the negative electrode plate;
storing the wound electrode body in the battery case;
injecting the nonaqueous electrolytic solution into the battery case in which the wound electrode body is stored, and forming a solution-injected battery into which the solution has been injected; and
initially charging the solution-injected battery,
wherein, in forming the positive electrode plate, hydroxide particles are supplied so as to be contained only in positive active material layer end portions existing on the surfaces of the current collecting foil end portions of the positive electrode laminated part in the positive active material layer.

3. The method for producing the lithium-ion secondary battery according to claim 2, wherein the hydroxide particles are LiOH particles.

4. A method for producing the lithium-ion secondary battery according to claim 1, the method comprising:
forming the positive electrode plate including the positive active material layer on the surface of the positive current collecting foil;
forming the wound electrode body by winding the positive electrode plate, the negative electrode plate, and the separator so that the separator is interposed between the positive electrode plate and the negative electrode plate;
storing the wound electrode body in the battery case;
injecting the nonaqueous electrolytic solution into the battery case in which the wound electrode body is stored, and forming a solution-injected battery into which the solution has been injected; and
initially charging the solution-injected battery,
wherein injecting the nonaqueous electrolytic solution is performed by injecting the nonaqueous electrolytic solution into the battery case that stores the wound electrode body configured such that:
each of an amount of water in positive active material layer end portions of the positive active material layer, existing on each of the surfaces of the current collecting foil end portions of the positive electrode laminated part, is equal to or higher than 100 ppm; and
an amount of water in a positive active material layer central portion of the positive active material layer, existing on the surface of the current collecting foil central portion of the positive electrode laminated part, is less than each of the amount of water in the positive active material layer end portions.

5. The method for producing the lithium-ion secondary battery according to claim 4, the method further comprising,
between storing the wound electrode body and injecting the nonaqueous electrolytic solution,
adjusting each of the amount of water in the positive active material layer end portions such that each of the amount of water in the positive active material layer end portions is 100 ppm or higher but 290 ppm or less, and adjusting the amount of water in the positive active material layer central portion such that the amount of water in the positive active material layer central portion is less than each of the amount of water in the positive active material layer end portions.
